(19) United States
(12) Patent Application Publication
(10) Pub. No.: US 2011/0214966 A1
(43) Pub. Date: Sep. 8, 2011

(54) FILM FORMING MATERIAL FEEDING APPARATUS

(76) Inventors: Kaname Mizokami, Kyoto (JP); Seiji Imanaka, Osaka (JP); Yoshinao Ooe, Kyoto (JP)

(21) Appl. No.: 12/677,148

(22) PCT Filed: Oct. 26, 2009
(86) PCT No.: PCT/JP2009/005620

§ 371 Date: Mar. 9, 2010

(30) Foreign Application Priority Data
Oct. 27, 2008 (JP) 2008-275110
Oct. 27, 2008 (JP) 2008-275111
Oct. 27, 2008 (JP) 2008-275112

(51) Int. Cl. B65G 37/00; B65G 11/00

(52) U.S. Cl. 198/523

(57) ABSTRACT

A film forming material feeding apparatus including a feeder, and a chute for sliding film forming materials supplied from the feeder into a material receiving part of a hearth, in which the chute has a bottom part for allowing the film forming materials to slide, and side parts provided at both sides of the bottom part, and the bottom part and the side parts are connected by way of an arc-shape part, and thereby bridging of the film forming materials on the chute is suppressed, so that a stable supply of the film forming materials may be realized.

### TECHNICAL FIELD

The present invention relates to a film forming material feeding apparatus for a film forming apparatus, and more particularly to a film forming material feeding apparatus for forming a protective film of an AC type plasma display panel.

### BACKGROUND ART

A plasma display panel (hereinafter called a PDP) is faster in display speed and wider in viewing angle as compared with a liquid crystal panel, and is easily increased in size, and it is now used widely also because of its high display quality by spontaneous light emission.

In an AC type PDP, a pair of substrates transparent on the front sides are disposed oppositely to form a discharge space between the substrates, and the discharge space is divided to plural sections by disposing barrier ribs in the substrates, and electrode groups are disposed on the substrates so that a discharge takes place in the discharge spaces partitioned by the barrier ribs. Further, phosphor layers emitting lights in red, green, and blue colors by discharge are provided, and a plurality of discharge cells are composed. The phosphor is excited by a vacuum ultraviolet light of short wavelength generated by discharge, and visible lights of red, green, and blue colors are emitted from discharge cells of red, green, and, blue colors, and thereby a color display is realized.

In the PDP of such configuration, the side exposed to the discharge space between the substrates is discharged, and the surface state is changed by sputtering due to ion bombardment. To avoid occurrence of such phenomenon, for example, a protective film of magnesium oxide (MgO) material is formed at the discharge space side of the substrates. Such protective film is generally formed by forming a film from a film forming material such as magnesium oxide (MgO) particles by an electron beam deposition method of evaporating by heating by using an electron beam.

At this time, an electron beam deposition apparatus as a film forming apparatus includes a film forming material feeding apparatus for supplying a film forming material into a hearth provided in a film forming chamber, and emits an electron beam to the film forming material in the hearth to evaporate the film forming material, and deposits the deposition particles on the moving substrates.

A feeding method of such film forming materials into the hearth is disclosed, for example, in patent document 1, in which the film forming materials supplied onto a chute from a feeder are charged into the hearth while sliding on the chute. In the film forming material feeding apparatus of such configuration, the chute plays a role of a guide for injecting the film forming materials onto a prescribed position in the hearth.

To form a protective film stably, it is required to supply the film forming materials stably into the hearth, and by stable sliding of the film forming materials on the chute, it is important to supply a prescribed amount stably into the prescribed position.

In the conventional chute, however, the film forming materials may be stuck and clogged on the chute to cause a phenomenon of so-called “bridge” and sliding of film forming materials may be blocked and may not flow smoothly. As a result, the supply of film forming materials into the hearth becomes unstable, it may be difficult to form a favorable protective film.

### Citation List

### Patent Literature

Patent Literature 1 Japanese Patent Application Unexamined Publication No. 2008-19473

### SUMMARY OF THE INVENTION

The film forming material feeding apparatus of the present invention is a film forming material feeding apparatus including a feeder, and a chute for sliding film forming material supplied from the feeder into a material receiving unit of a hearth, in which the chute has a bottom part for allowing the film forming material to slide, and side parts provided at both sides of the bottom part, and the bottom part and the side parts are connected by way of an arc-shape part.

In this configuration, when the film forming material slide on the chute, the film forming material is allowed to slide along the arc-shape part, and “bridging” of film forming material on the chute is suppressed, and the film forming material may be supplied stably.

### BRIEF DESCRIPTION OF DRAWINGS

FIG. 1 is a perspective view showing a structure of an AC type PDP.

FIG. 2 is a sectional view showing an outline configuration of a film forming apparatus for forming a protective film for a PDP by using a film forming material feeding apparatus in preferred embodiment 1.

FIG. 3 is a perspective view showing a structure of a chute in a conventional film forming material feeding apparatus.

FIG. 4 is a partial sectional view along line 4-4 shown in FIG. 3.

FIG. 5 is a sectional view showing the detail of pellet supply from a to feeder to a chute in the film forming material feeding apparatus.

FIG. 6 is a perspective view of the chute of a film forming material feeding apparatus in preferred embodiment 1.

FIG. 7A is a sectional view along line 7A-7A in FIG. 6.

FIG. 7B is a sectional view along line 7B-7B in FIG. 6.

FIG. 8 is a diagram showing the relation between the angle and bridge occurrence rate of side parts of the chute in preferred embodiment 1.

FIG. 9 is a perspective view showing a chute in preferred embodiment 2.

FIG. 10A is a sectional view along line 10A-10A in FIG. 9.

FIG. 10B is a sectional view along line 10B-10B in FIG. 9.

FIG. 11 is a perspective view showing a configuration of a chute and a hearth of a film forming material feeding apparatus in preferred embodiment 3.

FIG. 12A is a front view showing a configuration of the chute.

FIG. 12B is a magnified sectional view along line 12B-12B in FIG. 12A.

FIG. 12C is a magnified sectional view showing the detail of part I in FIG. 12A.

FIG. 13A is a front view showing a configuration of a chute of a film forming material feeding apparatus in preferred embodiment 4.

FIG. 13B is a sectional view along line 13B-13B in FIG. 13A.

FIG. 14 is a perspective view showing a configuration of a chute and a hearth of a film forming material feeding apparatus in preferred embodiment 5.

FIG. 15A is a plan view of the chute.

FIG. 15B is a side view of the chute.

FIG. 16 is a sectional view showing the relation of the chute and a hearth.

FIG. 17 is a front view of the chute as seen from the front side of the hearth.

### PREFERRED EMBODIMENTS FOR CARRYING OUT THE INVENTION

Preferred embodiments of the film forming material feeding apparatus of the present invention are specifically described below by reference to the accompanying drawings, but the present invention is not limited to these preferred embodiments alone.

### Preferred Embodiment 1

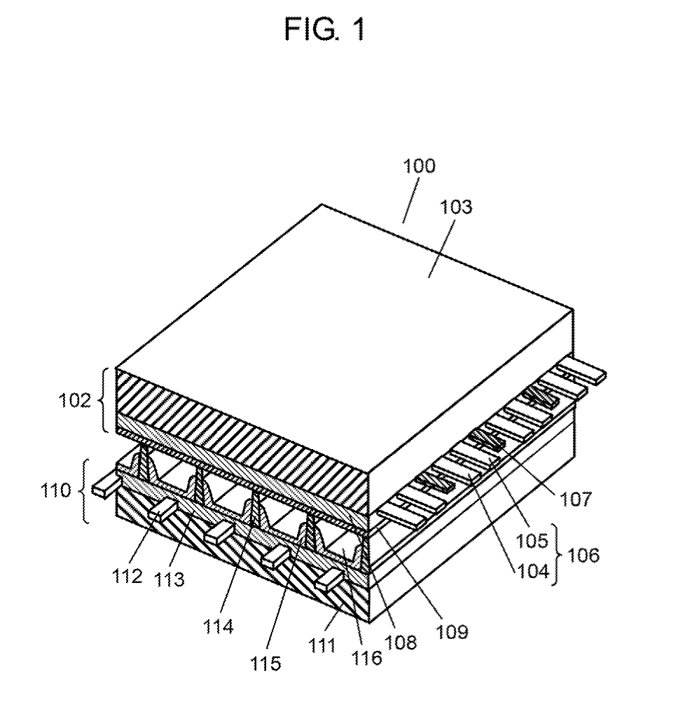

A structure of a PDP to be manufactured by applying a film forming material feeding apparatus of the present invention is described below by reference to FIG. 1. FIG. 1 is a perspective view showing a structure of PDP 100 of AC type. As shown in FIG. 1, PDP 100 has front panel 102 made of front glass substrate 103 or the like, and rear panel 110 made of rear glass substrate 111 of the like disposed oppositely to each other, and the outer circumference is hermetically sealed by a sealing material such as glass frit. Discharge spaces 116 in the sealed inside of PDP 100 are packed with a discharge gas such as xenon (Xe) or neon (Ne) at a pressure of about 66500 Pa.

On front glass substrate 103 of front panel 102, a pair of band-like display electrodes 106 consisting of scan electrodes 104 and sustain electrodes 105 and black stripes (light shielding layers) 107 are disposed in a plurality of columns mutually in parallel to each other. On front glass substrate 103, dielectric layer 108 functioning as a capacitor by holding an electric charge so as to cover display electrodes 106 and black stripes (light shielding layers) 107 is formed, and protective layer 109 is formed further thereon.

On rear glass substrate 111 of rear panel 110, a plurality of band-like address electrodes 112 are disposed mutually in parallel to each other, in a direction orthogonal to scan electrodes 104 and sustain electrodes 105 of front panel 102, and they are covered with base dielectric layer 113. Further on base dielectric layer 113 between address electrodes 112, barrier ribs 114 of a prescribed height are formed for partitioning discharge spaces 116. In every groove between barrier ribs 114, phosphor layers 115 for emitting lights in red, green, and blue colors by ultraviolet rays are formed. Discharge spaces 116 are formed at intersecting positions of scan electrodes 104, sustain electrodes 105, and address electrodes 112, and discharge spaces 116 having phosphor layers 115 of red, green, and blue colors arranged in the direction of display electrodes 106 are pixels for color display.

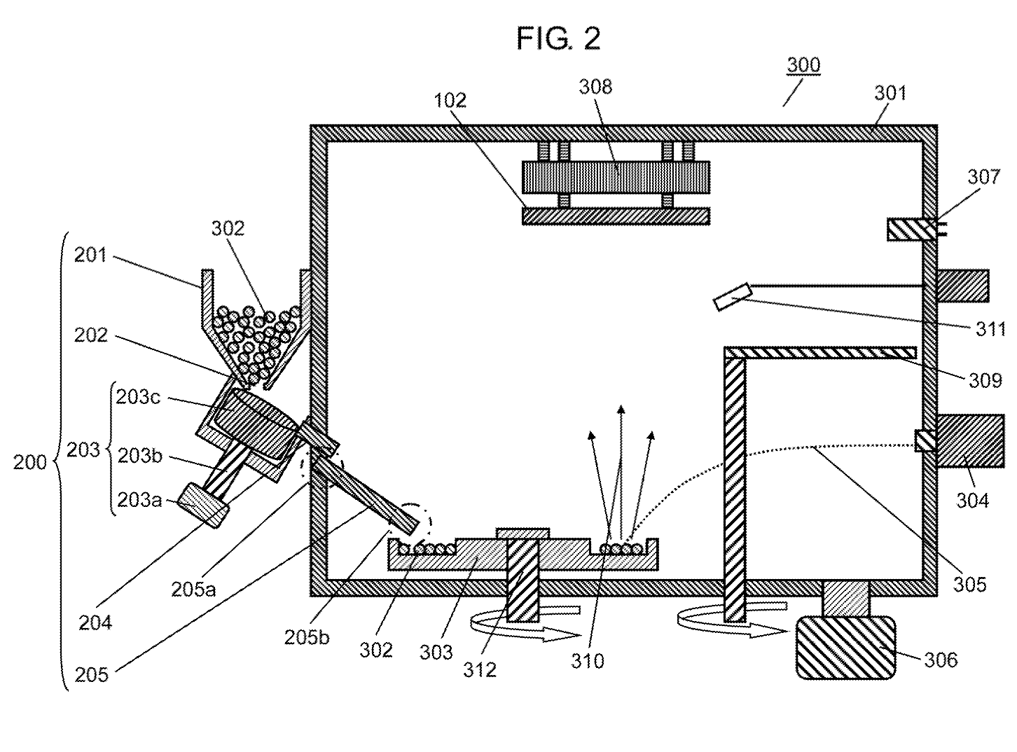

The next explanation is about film forming apparatus 300 for forming protective film 109. FIG. 2 is a sectional view showing an outline configuration of film forming apparatus 300 for forming protective film 109 for PDP 100 by using film forming material feeding apparatus 200 in preferred embodiment 1. Film forming apparatus 300 is an electron beam (EB) evaporating apparatus for evaporating film forming material 302 by to heating and fusing by electron beams 305.

Film forming apparatus 300 has hearth 303 filled with film forming materials 302 disposed in the inside of vacuum chamber 301 which is a vacuum container. Electron beam sources 304 are disposed on the side walls of vacuum chamber 301, and electron beams 305 are emitted from electron beam sources 304 onto film forming material 302 on hearth 303. The emitting position of electron beam 305 is controlled by controlling an electromagnet (not shown) of a magnetic circuit disposed at the side of hearth 303. The configuration also includes vacuum pump 306 for evacuating and exhausting vacuum chamber 301 and vacuum meter 307 for measuring the degree of vacuum.

Nearly above hearth 303, front panel 102 display electrodes 106, black stripes (light shielding layers) 107, and dielectric layers 108 is disposed on front glass substrate 103 of PDP 100, and further above this front panel 102, heater 308 is disposed for heating front panel 102 in the film forming process. Between front panel 102 and hearth 303, shutter plate 309 is disposed, and by rotating shutter plate 309, deposition particles 310 are prevented from sticking to front panel 102 unexpectedly at other timing than the film forming process. The film thickness of protective film 109 formed on front panel 102 is measured by film thickness monitor 311 whenever necessary.

As protective film 109 of PDP 100, a thin film of magnesium oxide (MgO) is used. in this preferred embodiment of the present invention, film forming material 302 is a material mainly composed of magnesium oxide (MgO).

Electron beam 305 is emitted to film forming material 302 contained in hearth 303, and film forming material 302 is evaporated, and deposition particles 310 are deposited on dielectric layer 108 of front panel 102, and thereby protective film 109 is formed.

Further, as shown in FIG. 2, since hearth 303 can be rotated by rotation shaft 312, and the supply position of film forming material 302 and the emitting position of electron beam 305 may be different in hearth 303.

Film forming material 302 in hearth 303 is consumed by heating and evaporating operations in the film forming process. To replenish with film forming material 302, film forming material feeding apparatus 200 is connected to film forming apparatus 300. Film forming material feeding apparatus 200 includes material hopper 201, feeder 203 disposed immediately beneath discharge port 202 of material hopper 201, and chute 205 connected to feeder discharge port 204 of feeder 203. Material hopper 201 and feeder 203 are installed in an evacuated and exhausted vacuum container chamber (not shown). The vacuum container chamber is a preliminary vacuum compartment for removing the moisture adsorbed on film forming material 302 of magnesium oxide (MgO), and minimizing the drop of degree of vacuum in vacuum chamber 301 when supplying film forming material 302.

An opening and closing valve (not shown) is provided in discharge port 202 of material hopper 201 of film forming material feeding apparatus 200, and by opening and closing of the opening and closing valve, supply of film farming material 302 into feeder 203 is controlled. As shown in FIG. 2, feeder 203 is further provided with drive motor 203a at its lower part, drive shaft 203b of drive motor 203a is connected to a screw (not shown) or the like in inclined and disposed container 203c. By rotation of the screw in container 203c, film forming material 302 is supplied into container 203c of feeder 203 from material hopper 201, and is conveyed into the upper part from the bottom of container 203c. As a result, the material drops into chute 205 from feeder discharge port 204 at the upper end of inclined container 203c.

The supply amount of film forming material 302 into chute 205, that is, the supply amount of film forming material 302 into hearth 303 is controlled by controlling the rotating speed of drive motor 203a or the like.

Referring now to FIG. 2, a method of feeding film forming material 302 into hearth 303 is explained specifically below. Material hopper 201 contains a required amount of pellets of magnesium oxide (MgO) as film forming material 302 depending on the duration of continuous operation. For example, when film forming apparatus 300 is operated continuously for a prescribed period, film forming material 302 is contained in material hopper 201 by an amount corresponding to the consumption in hearth 303 in this period. The lower part of material hopper 201 is formed like a funnel, and opening or closing of the opening and closing valve provided in discharge port 202 is controlled, and the supply into feeder 203 is controlled, so that the amount of film forming material 302 in container 203c is controlled to be nearly constant all the time.

Feeder 203 has a ribbon-shaped screw rotating by inclining the axial center on the inner circumference of container 203c, and is coupled to drive motor 203a by way of drive shaft 203b. Container 203c is disposed with its central axis inclined at an angle of 50 degrees to 60 degrees to the horizontal plane.

Film forming material 302 supplied in container 203c of feeder 203 is transferred to above container 203c by rotation of the screw, and falls from feeder discharge port 204 at the upper end side at the lowest position of container 203c, and a prescribed amount is supplied into upper end part 205 of chute 205.

Upper end part 205a of chute 205 is positioned at the upper end side of container 203c, and its lower end part 205b is positioned in hearth 303, and on the whole it is inclined and positioned from container 203c toward hearth 303. That is, film forming material 302 supplied into upper end part 205a of chute 205 is supplied into hearth 303 while sliding on chute 205.

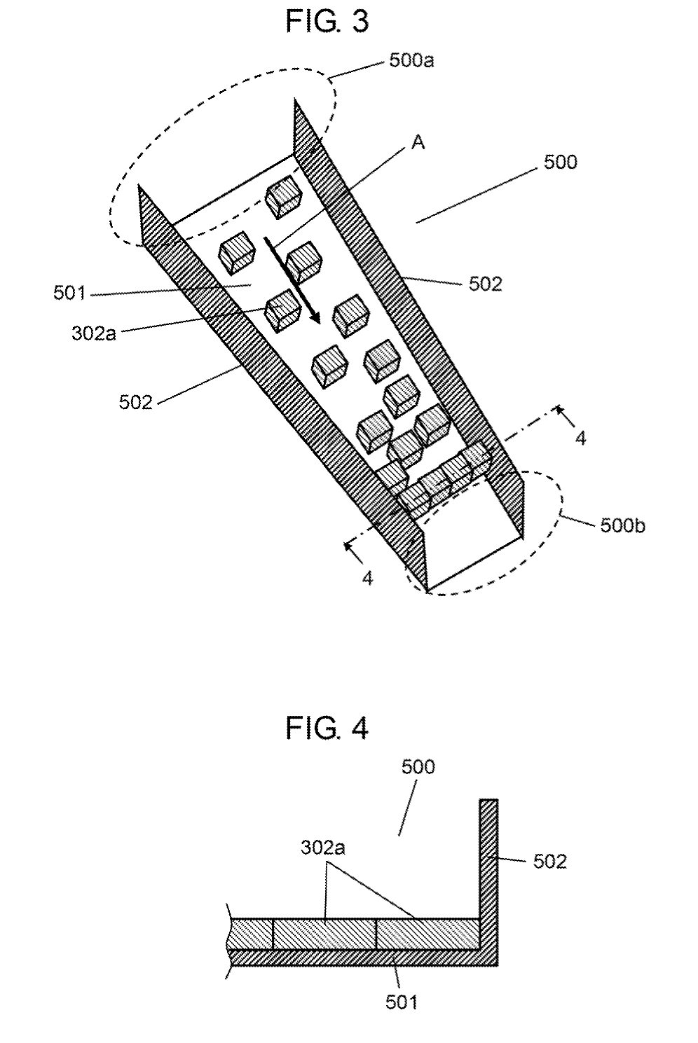

FIG. 3 is a perspective view showing a configuration of chute 500 in a conventional film forming material feeding apparatus. FIG. 4 is a partial sectional view along line 4-4 in FIG. 3. As shown in FIG. 3, chute 00 is formed of a thin plate material, and is composed of bottom part 501 as the sliding surface of pellets 302a of film forming material 302 in the direction of arrow A, and side parts 502 provided at both sides of bottom part 501 playing the role of guide plate for allowing sliding of pellets 302a. From upper end part 500a to lower end part 500b of chute 500, the passage area formed by side parts 502 is composed to be reduced, so that film forming material 302 may be supplied securely into a specified position in hearth 303. Also as shown in FIG. 4, side parts 502 are composed to stand up nearly vertically to bottom part 501 by folding and bending processing of plate metals.

As mentioned above, protective film 109 of PDP 100 is formed of a to material mainly composed of magnesium oxide (Mg0). Therefore, film forming material 302 is made of pellets 302a of material adjusted sinter or the like mainly composed of magnesium oxide (MgO). The shape of pellets 302a varies with the manufacturing method or the processing method, and includes a spherical shape, a cylindrical shape, a plate shape and others.

In the case of pellets 302a of spherical shape, pellets 302a slide stably on chute 500. However, in the case of pellets 302a of circular column shape or circular plate having a flat surface, or in the case of a flat plate shape, a frictional force acts between bottom part 501 of chute 500 and the flat surface of pellets 302a in FIG. 3. As a result, a resistance occurs between chute 500 and pellets 302a, and smooth sliding is hindered.

In the case of pellets 302a mainly composed of magnesium oxide (MgO), moisture is easily adsorbed by magnesium oxide (MgO), and if the moisture is removed in a vacuum container chamber in which material hopper 201 or the like is contained, the sliding resistance is increased by the moisture sticking to the surfaced of pellets 302a.

When the sliding speed is lowered by such resistance, sliding of pellets 302a from the upstream is restricted by pellets 302a lowered in sliding speed, and the flow may be stagnant on chute 500. As a result, as shown in FIG. 3, at the lower end 500b side of chute 500 reduced in the passage area, pellets 302a are clogged and straighten in flow between both side parts 502, and so-called bridge phenomenon may occur. Hence, pellets 302a are clogged and arrested within the passage in chute 500, and prevented from sliding on chute 500. In other words, such phenomenon occurs because both side parts 502 provided in chute 500 as guide plates restrict the flow of pellets 3002a.

In particular, this phenomenon is more evident when side parts 502 functioning as guide plates provided in chute 500 are formed at a rising angle of 90 degrees or less to bottom part 501, that is, when pellets 302a are guided to the inside of chute 500 by both side parts 502.

When such phenomenon occurs, supply of film forming material 302 into hearth 303 may be stopped, or the bridge may be suddenly release to cause an excessive supply, and other unstable states may occur. If such troubles occur during continuous operation of film forming apparatus 300, formation of protective film 109 of magnesium oxide (MgO) on dielectric layer 108 of front glass substrate 103 becomes unstable. To restore from such bridge phenomena, it is required to stop the operation of film forming apparatus 300 temporarily, and remove completely pellets 302a collected on chute 500, and the operation rate of film forming apparatus 300 is lowered.

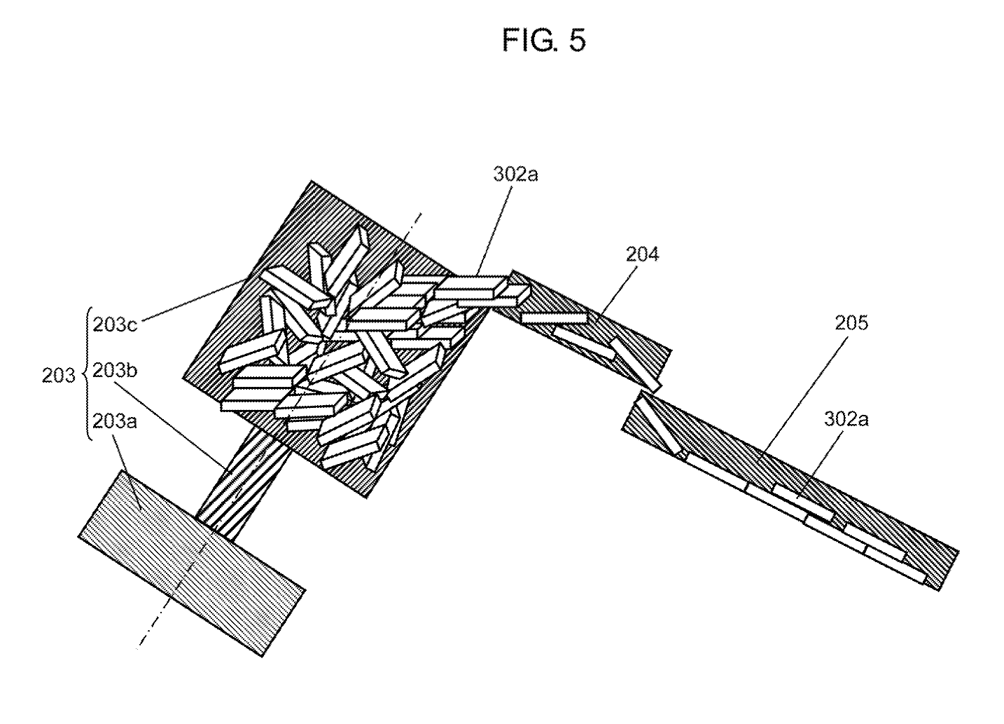

Such bridge phenomena are also caused by a sudden and excessive supply of materials from feeder 203. FIG. 5 is a sectional view showing the detail of supply of pellets 302a from feeder 203 into chute 205 in film forming material feeding apparatus 200, and schematically shows a case of mass supply of pellets 302a into feeder 203 from material hopper 201.

As shown in FIG. 5, when pellets 302a fall into material hopper 201 massively, pellets 302a in container 203c may not transferred from the lower part of container 203c by rotation of drive motor 203a, but may overflow from the upper surface of container 203c. The overflowing portion of pellets 302a may pass through feeder discharge port 204 to reach chute 205. Thus, a large quantity of pellets 302a may slide on chute 205. As a result, the discharge amount determined by the resistance by sliding and the passage area in lower end part 205b of chute 205 cannot catch up with the supply amount, and a bridge phenomenon is likely to occur.

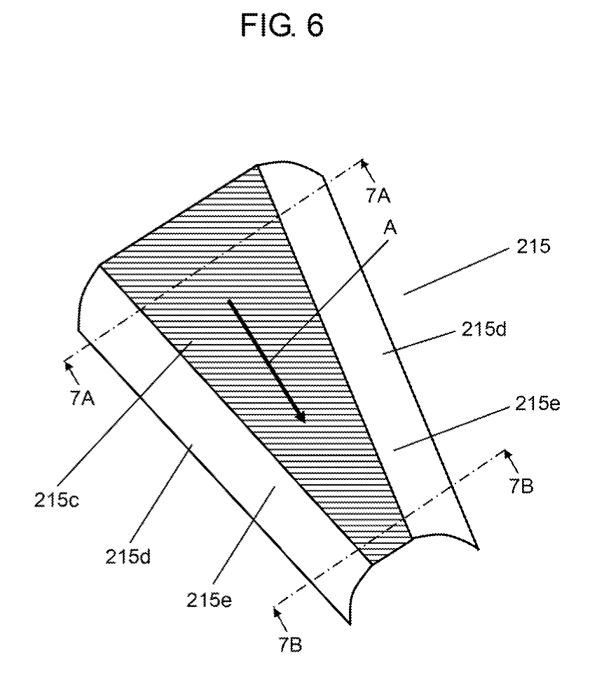

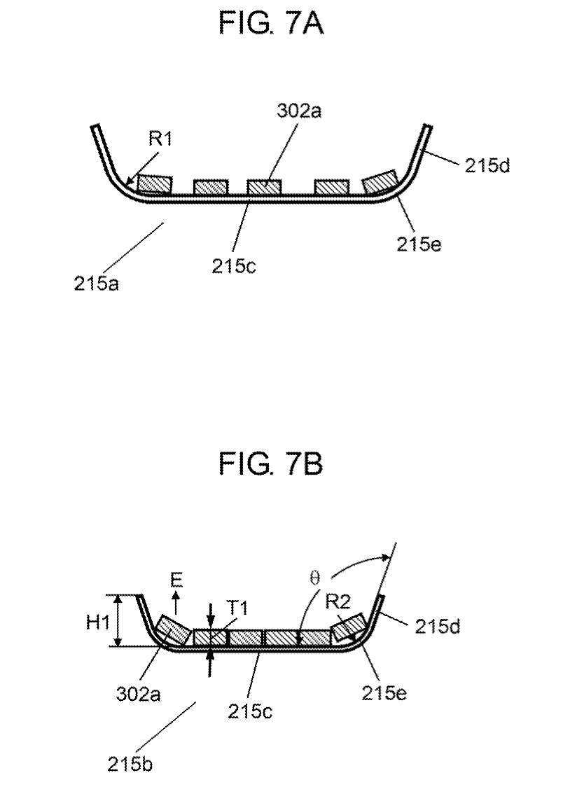

Next, film forming material feeding apparatus 200 in preferred embodiment 1 is explained below. FIG. 6 is a perspective view of chute 215 of film forming material feeding apparatus 200 in preferred embodiment 1. FIG. 7A is a sectional view along line 7A-7A in FIG. 6, showing upper end part 215a of chute 215. FIG. 7B is a sectional view along line 6D-6D in FIG. 6, showing lower end part 215b of chute 215. In preferred embodiment 1, film forming material 302 is made of pellets 302a having a similar flat surface as used in chute 500 of the prior art in FIG. 3.

As shown in FIG. 6, FIG. 7A, FIG. 7B, chute 215 of film forming material feeding apparatus 200 in preferred embodiment 1 has bottom part 215c as sliding surface of pellets 302a, and side parts 215d provided at both sides of bottom part 215c, and bottom part 215c and side parts 215d are connected by way of arc-shape part 215e. The width of bottom part 215 is gradually decreased in a direction toward arrow A in the sliding direction of pellets 302a, and a trough-like shape is formed on the whole.

The radius of arc-shape part 215e differs between upper end part 215a and lower end part 215b because of a continuous structure, and radius R2 of lower end part 215b may be smaller than radius R1 of upper end part 215a. In preferred embodiment 1, in particular, to suppress the bridge phenomenon of pellets 302a at lower end part 215b, radius R2 of arc-shape part 215e at lower end part 215b is important. Radius R2 is determined in relation to the shape and dimension of pellets 302a, and for example, in the case of pellets 302a of 5 mm square or more to 20 mm square or less, and plate thickness of 1 mm or more to 5 mm or less, it is experimentally confirmed that radius R2 is preferred to be 10 mm or more.

That is, in preferred embodiment 1, bottom part 215c and side parts 215d of chute 215 are connected by way of arc-shape part 215e. Hence, as shown in FIG. 7B, at lower end part 215b of chute 215, if pellets 302a are straightened in the width direction in bottom part 215c, since arc-shape part 215e is present, the end portions of pellets 302a receive a force in an upward direction E along the arc. Therefore it is free from occurrence of force of pressing pellets 302a inward into chute 215 by side parts 215d and pellets 302a. it is hence possible to suppress occurrence of bridge phenomenon of clogging and straightening of pellets 302a on chute 215. On chute 215, therefore, pellets 302a slide continuously and stably, and protective film 109 may be formed stably.

In particular, when pellets 302a are made of a moisture absorbing material such as magnesium oxide (MgO), due to the adsorbed moisture, pellets 302a are likely to stick to bottom part 215c of chute 215, but in chute 215 of preferred embodiment 1, even in such circumstances, such bridge phenomenon of pellets 302a can be suppressed.

As shown in FIG. 6, FIG. 7A, FIG. 7B, side parts 215d are preferred to be formed at an obtuse angle to bottom part 215c, that is, angle θ is preferred to be 90 degrees or more. In such configuration, if pellets 302a are straightened in the width direction of bottom part 215c of chute 215, the end parts of pellets 302a abutting against the side parts 215d always receive an upward force. As a result, by side parts 215d and pellets 302a, the force of pressing pellets 302a to the inner side of chute 215 is not generated, and bridge phenomenon of straightening anti clogging of pellets 302a on chute 215 can be suppressed further securely.

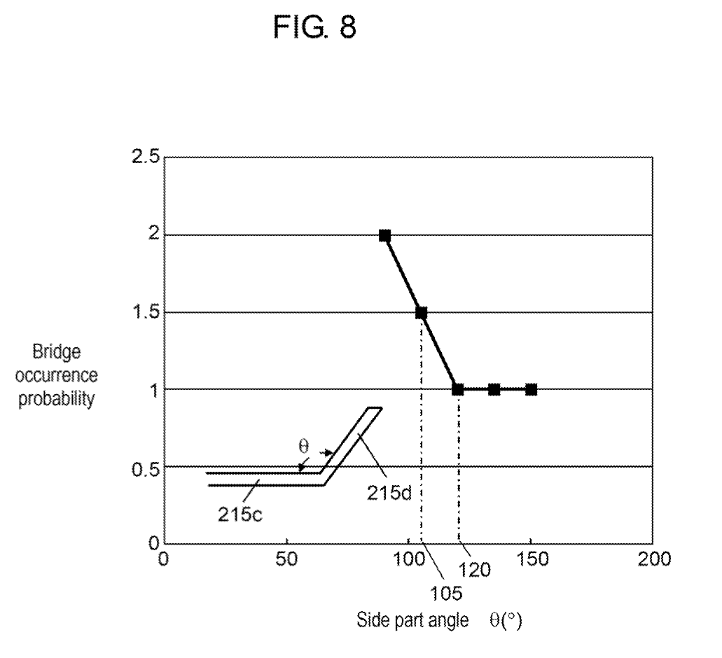

FIG. 8 is a diagram showing the relation of angle of side parts 215d of chute 215 and probability of occurrence of bridge phenomenon in preferred embodiment 1. In FIG. 8, in relation to angle θ formed between side parts 215d and bottom part 215c, the number of times of occurrence of bridge phenomenon is experimentally determined, and angle θ of 180 degrees, that is, the absence of side parts 215d is supposed to be 1. In this experiment, arc-shape part 215e is not formed intentionally in the connection parts between bottom part 215c and side parts 215d, and metal plates were processed at radius R of connection parts of 1 mm or less. In this case, pellets 302a were box-shape pellets 302a of 5 mm×7 mm, and 2 mm in thickness, and radius R of ridge of each side of pellets 302a was 0.5 mm.

As clear from the results shown in FIG. 8, when angle θ is 120 degrees or more, occurrence of bridge phenomenon can be suppressed, and when it is an obtuse angle exceeding 105 degrees, the probability of bridge occurrence can be decreased. Further, in the results in FIG. 8, arc-shape part 215e is not formed intentionally in the connection parts between bottom part 215c and side parts 215d, but when arc-shape part 215e of R2 of 10 mm is provided, as mentioned above, if angle θ is 90 degrees, occurrence of bridge phenomenon can be suppressed.

Meanwhile, as shown in FIG. 7B, in the case of film forming material 302 made of pellets 302a of plate material of a prescribed thickness, if the thickness is T1, height H1 of side parts 215d from bottom part 215c is desired to be greater than T1. According to such configuration, pellets 302a moving on the upper side of chute 215 along arc-shape part 215e and side parts 215d may be prevented from sliding outside of chute 215 by surpassing side parts 215d. A this time, the bridge phenomenon of pellets 302a can be suppressed by side parts 215d disposed at obtuse angle θ to arc-shape part 215e or bottom part 215c, so that pellets 302a are allowed to slide stably on chute 215.

Herein, height H1 is determined in relation to the shape and dimension of pellets 302a. For example, in the case of pellets 302a measuring 5 mm square or more to 20 mm square or less, and plate thickness T1 of 1 mm or more to 5 mm or less. H1 is preferred to be 10 mm or more.

### Preferred Embodiment 2

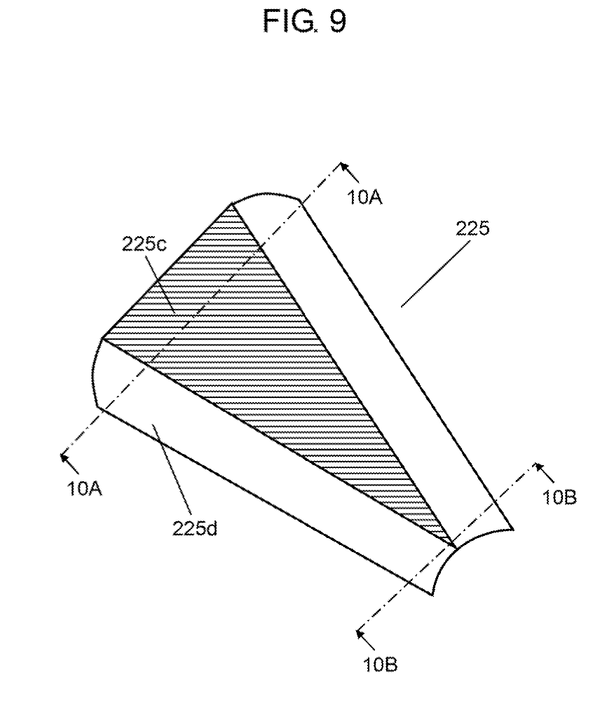

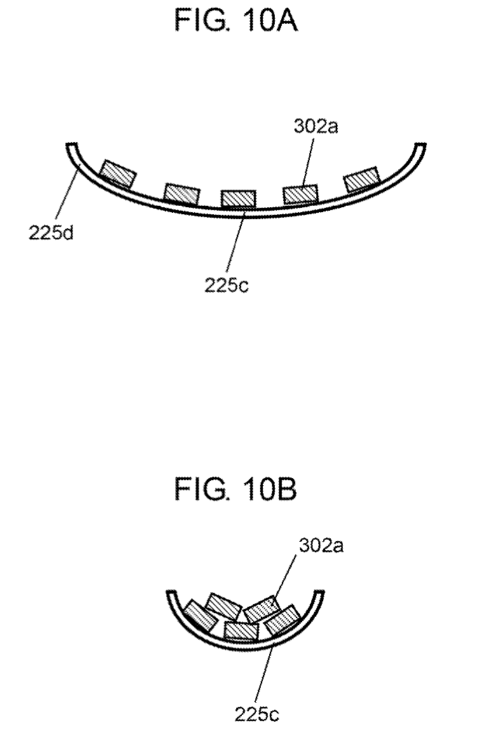

FIG. 9 is a perspective view of chute 225 in film forming material feeding apparatus 200 in preferred embodiment 2. FIG. 10A is a sectional view along line 10A-10A in FIG. 9, showing an upper end part of chute 225. FIG. 10B is a sectional view along line 10B-10B in FIG. 9, shoving a lower end part of chute 225.

As shown in FIG. 10A, FIG. 10B, chute 225 in preferred embodiment 2 does not have flat part such as bottom part 215c provided in chute 215 shown in FIG. 3. That is, in chute 225, bottom part 225c and side parts 225d are formed as a continuous arc shape, chute 225 does not have surface contacting flatly with the flat part of pellets 302a.

By such configuration, surface contact of flat parts of pellets 302a is prevented, and it is effective to suppressing blocking of sliding of pellets 302a due to the friction. In particular, a portion free from flat part is formed in the lower end part of chute 225, that is, in a region close to the supply end of hearth 303, and pellets 302a can be supplied more stably. Also in this configuration, any force of pressing pellets 302a in an inward direction of chute 225 is not generated, and occurrence of bridge phenomenon can be further suppressed.

### Preferred Embodiment 3

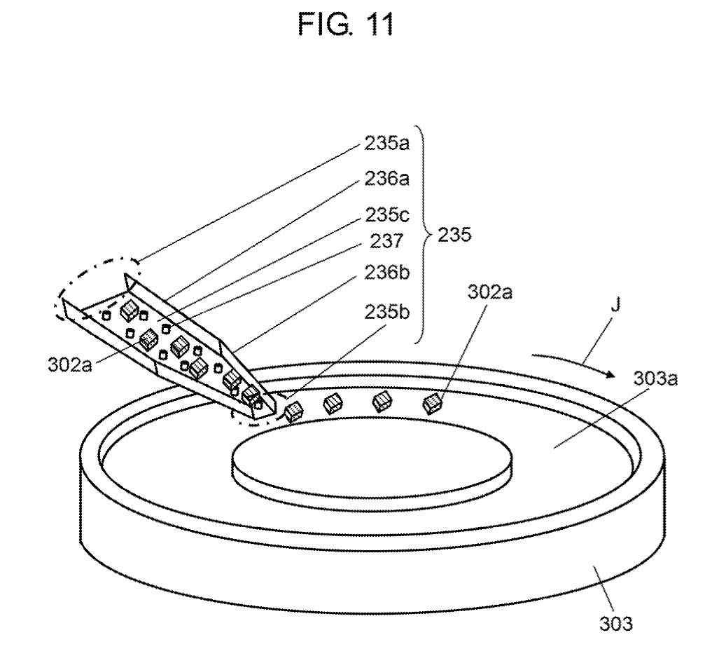

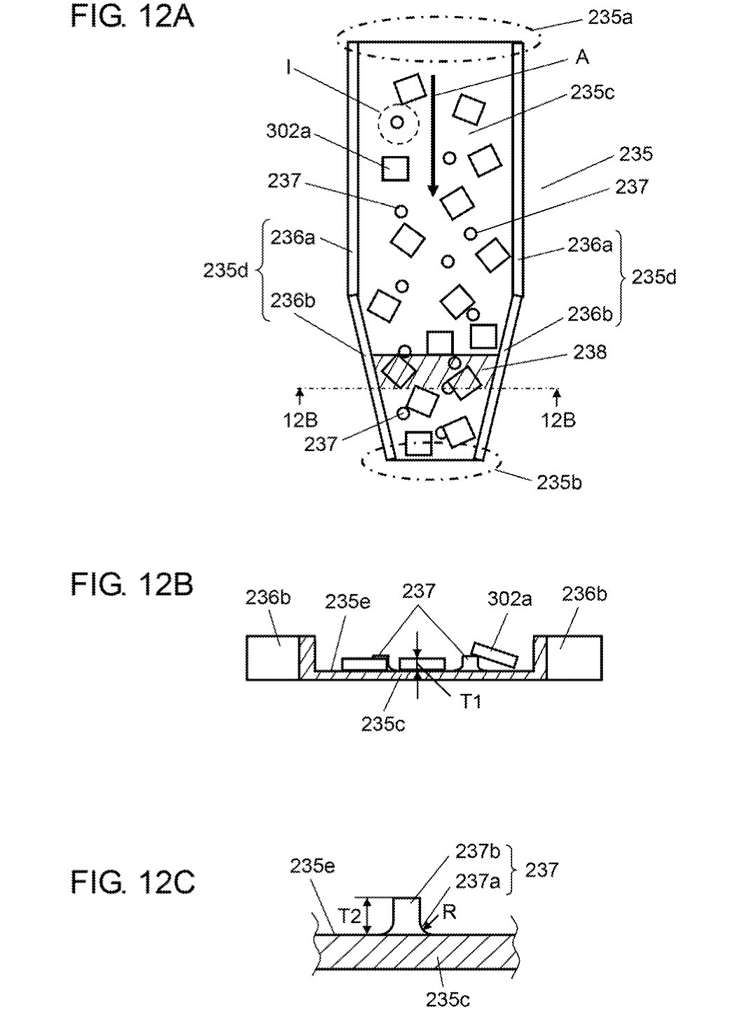

Next, referring to preferred embodiment 3, chute 235 of film forming material feeding apparatus 200 is specifically described below. FIG. 11 is a perspective view showing a configuration of chute 235 and hearth 303 of film forming material feeding apparatus 200 in preferred embodiment 3. FIG. 12A is a front view showing a configuration of chute 235. FIG. 12B is a magnified sectional view along line 12B-12B in FIG. 12A, and FIG. 12C is a magnified sectional view showing the detail of part I in FIG. 12A. In the following explanation, film forming material 302 is made of pellets 302 of flat plate shape.

As shown in FIG. 11, material receiving part 303a having a prescribed depth is provided concentrically and circularly on the upper surface of hearth 303 formed as a rotating body on the whole, and hearth 303 rotates in a direction of arrow J, so that material receiving part 303a also rotates in the direction of arrow J. As shown in FIG. 11, chute 235 is inclined from upper end part 235a to lower end part 235b to the horizontal surface of hearth 303, and its lower end part 235b is disposed so as to be to opened toward material receiving part 303a.

On the other hand, chute 235 is composed as shown in FIG. 12A. That is, chute 235 is formed of thin plate materials or the like, and is composed of bottom part 235c playing the role of a guide plate for sliding of pellets 302a, and side parts 235d provide at both sides of bottom part 235c playing the role of a guide plate for sliding of pellets 302a. Side parts 235d have side part 236a and side part 236b. Pellets 302a slide on chute 235 in a direction of arrow A, and right and left side parts 236b decrease the passage area of chute 235. The height of side parts 235d from bottom part 235c is preferred to be more than the maximum length of pellets 203a of film forming material 302 so that pellets 302a may not ride over side parts 235d to drop out of chute 235.

As shown in FIG. 11, FIG. 12A, FIG. 12B, bottom part 235c of chute 235 of film forming material feeding apparatus 200 in preferred embodiment 3 is provided with protrusion 237 for lifting pellets 302a from bottom part 235c when pellets 302a slide on bottom part 235c.

As shown in FIG. 12A, in preferred embodiment 3, a plurality of protrusions 237 are formed at prescribed positions in bottom part 235c of chute 235. Protrusions 237 are upright on flat part 235e of bottom part 235c as shown in FIG. 12A, B, C, and are firmed of R-shaped parts 237a and convex parts 237b connected to flat parts 235e in a prescribed R shape.

That is, R-shaped parts 237a provided in protrusions 237 are designed to lift pellets 302a sliding on flat parts 235e from flat parts 235e of bottom part 235c. Initially, the bridge phenomenon of pellets 302a is caused when mutually adjacent pellets 302a confine with each other at mutual end to parts in a direction parallel to bottom part 235c, and the entire pellets are confined by side parts 235d of chute 235.

However, by using protrusions 237 of preferred embodiment 3, it is possible to suppress such restrictions. That is, among pellets 302a sliding on flat parts 235e, pellets 302a hitting against protrusions 237 are lifted in the upward direction at the end parts of pellets 302a by R-shaped parts 237a provided in protrusions 237. As a result, as shown in FIG. 12B, adjacent pellets 302a are not confined in same surface direction. Hence, if confined on side parts 235d, in the width direction of bottom part 235c, that is, in the direction of line 12B-12B in FIG. 12A, pellets 302a are not straightened and confined.

The size of radius R of R-shaped parts 237a varies with the relation to the shape of pellets 302a of film forming material 302, and in particular in the case of pellets 302a of flat plate shape, it is determined by the edge shape of end part of pellets 302a. That is, if the edge shape is at right angle, an R-shape of a larger curvature is desired, but if the edge shape of pellets 302a is an R-shape, the curvature may be small. That is, it is enough as far as pellets are formed in such a shape to be lifted when pellets 302a sliding and hitting against protrusions 237 are changed into an upward direction along protrusions 237 by R-shaped parts 237a. In the case of pellets 302a of flat plate shape, it is sufficient as far as the radius R of corner parts is more than thickness T1 of minimum length of flat plate. Similarly, height T2 of protrusions 237 from flat part 235e may be desired to be at least more than thickness T1 of pellets 302a.

Further, as shown in FIG. 12A, at least one protrusion 237 is formed in area 238 orthogonal to arrow A in a sliding direction of pellets 302a of bottom part 235c and having a maximum length of pellets 302a. In preferred embodiment 3, pellets 302a are flat plates of nearly square shape in a plan view, and in this case the maximum length is the diagonal line of the square. In such configuration, in direction 12B-12B in a direction vertical to the sliding direction of pellets 302a, at least one pellet 302a is lifted from bottom part 235e, and hence pellets are not confined and straightened by both side parts 235d.

Incidentally, protrusions 237 may be formed on the overall length in the sliding direction of pellets 302a, but may be formed only near lower end part 235b of chute 235, in particular.

The shape of protrusions 237 is not particularly limited to the shape specified herein, but may be formed, for example, to have a taper part in the sliding direction. In such configuration, when sliding on bottom part 235c, pellets 302a may ride on the taper part, so that the pellets 302a may be lifted from bottom part 235e.

### Preferred Embodiment 4

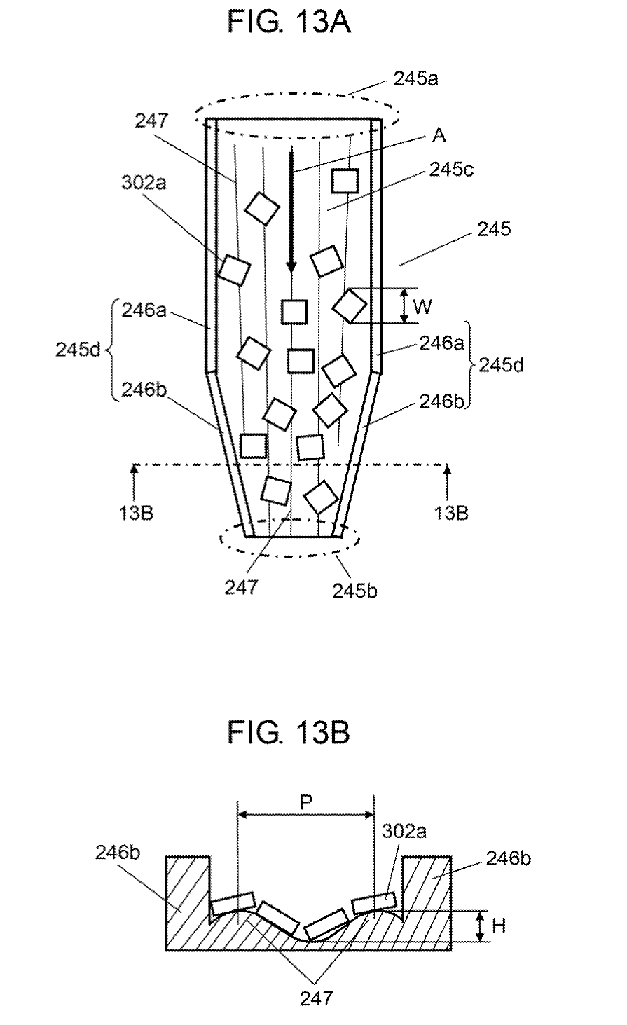

FIG. 13A is a front view of chute 245 in film forming material feeding apparatus 200 in preferred embodiment 4. FIG. 13B is a sectional view along line 13B-13B in FIG. 13A.

As shown in FIG. 13A, a basic configuration of chute 245 in preferred embodiment 4 is same as that of chute 235 in preferred embodiment 3 shown in FIG. 12A. That is chute 245 is formed of thin plate materials or the like, and is composed of bottom part 245c for allowing sliding of pellets 302a as to film forming material 302, and side parts 245d provide at both sides of bottom part 245c for playing the role as guide plates for sliding of pellets 302a. Side parts 245d have side part 246a and side part 246b. Pellets 302a slide on chute 245 in a direction of arrow A, and right and left side parts 246b decrease the passage area.

Chute 245 in preferred embodiment 4 differs from preferred embodiment 3 in the configuration of bottom part 245c. That is, bottom part 245c of chute 245 is provided with wave-shaped protrusions 247 in a direction orthogonal to the sliding direction of pellets 302a as shown in FIG. 13A, B.

Wave-shaped protrusions 247 are formed in prescribed pitch P and prescribed amplitude H, and are composed by folding and processing thin plate materials in preferred embodiment 4. Wave-shaped protrusions 247 are formed in stripes continuously from upper end part 245a to lower end part 245b of chute 245.

By forming wave-shaped protrusions 247, it is effective to suppress occurrence of bridge phenomenon of pellets 302a sliding on chute 245. That is, same as explained in preferred embodiment 3, the bridge phenomenon of pellets 302a is caused by mutually adjacent pellets 302a when the mutual end parts confine each other in surface directions parallel to bottom part 245c, and are entirely confined by side parts 245d of chute 245.

However by wave-shaped protrusions 247 of preferred embodiment 4, such confining actions can be suppressed. That is, pellets 302a sliding along bottom part 245c fall along down wave-shaped protrusions 247 as shown in FIG. 13A, B, and mutual end parts of adjacent pellet 302a do not confine each other on a same plane. Hence, if confined on side parts 245d, in the width direction of bottom part 245c, that is, in the direction of line 13B-13B in FIG. 13, pellets 302a are not straightened and confined.

Meanwhile, pitch P and amplitude H of wave-shaped protrusions 247 are determined in relation to the shape of pellets 302a of film forming material 302. More specifically, when pellets 302a are in a flat plate shape, pitch P is preferred to be more than diagonal line dimension W of the flat plate of the maximum size of pellets 302a, and amplitude H is preferred to be more than thickness T1 of pellets 302a of minimum size.

In FIG. 13A, wave-shaped protrusions 247 are provided in the overall length of the sliding direction of pellets 302a of chute 245, but may be also provided near lower end part 245b of chute 245 where bridge phenomenon is likely to occur.

### Preferred Embodiment 5

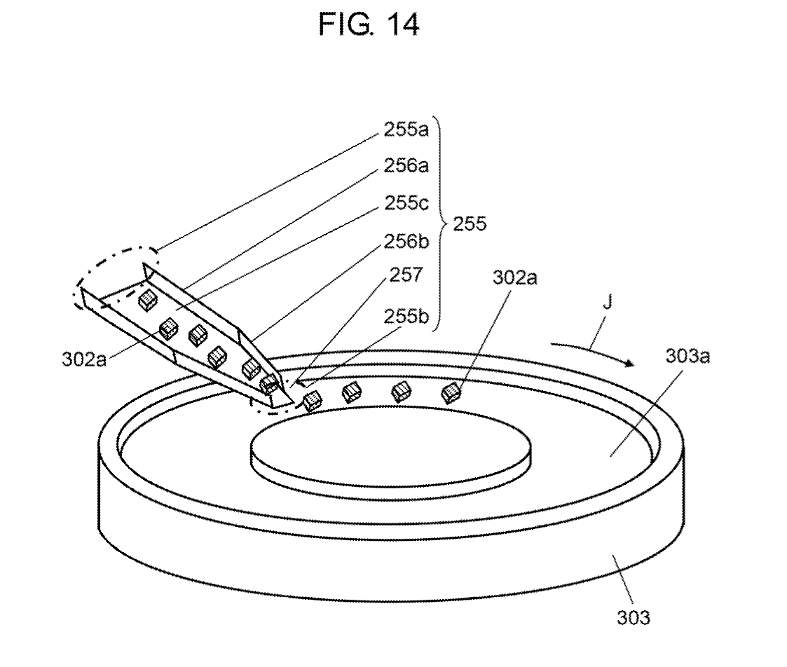

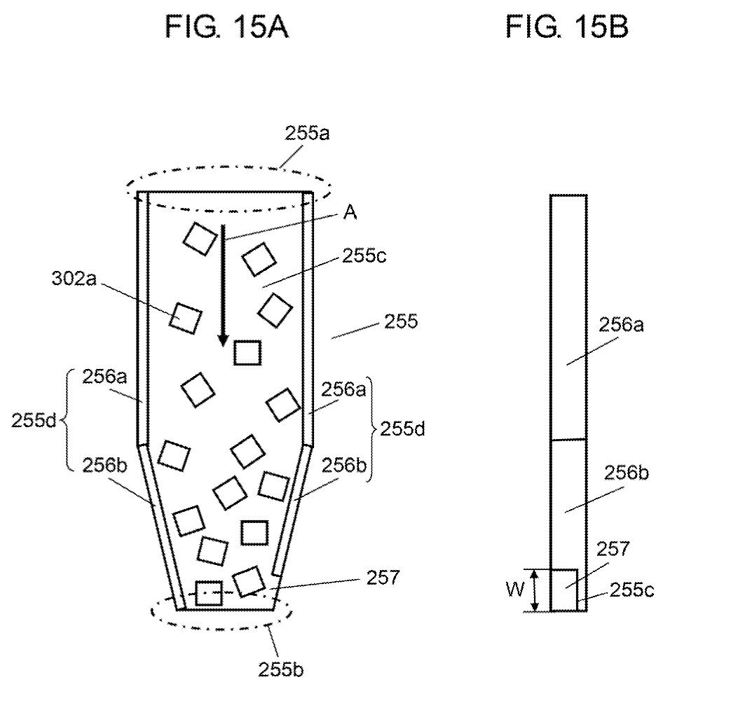

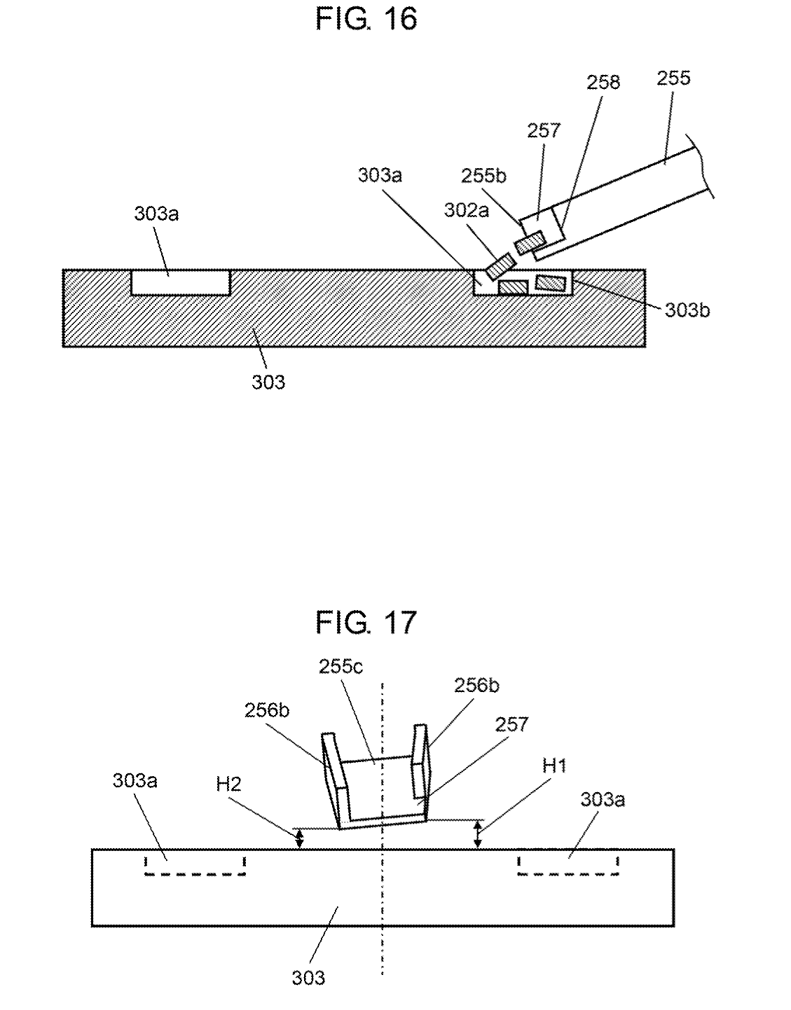

Next, referring to preferred embodiment 5, chute 255 of film forming material feeding apparatus 200 is specifically described below. FIG. 14 is a perspective view showing a configuration of chute 255 and hearth 303 of film forming material feeding apparatus 200 in preferred embodiment 5. FIG. 15A is a plan view of chute 255, and FIG. 15B is its side sectional view. FIG. 16 is a sectional view showing a configuration relation of chute 255 and hearth 303, and FIG. 17 is a front view of chute 255 as seen from the front side of hearth 303. In FIG. 14 to FIG. 17, film forming material 302 is also made of pellets 302a of flat plate shape.

As shown in FIG. 14, material receiving part 303a having a prescribed depth is provided concentrically and circularly on the upper surface of hearth 303 formed as a rotating body on the whole, and hearth 303 rotates in a direction of arrow J, so that material receiving part 303a also rotates in the direction of arrow J. As shown in FIG. 14 and FIG. 16, chute 255 is inclined from upper end part 255a to lower end part 255b to the horizontal surface of hearth 303, and its lower end part 255b is disposed so as to be opened toward material receiving part 303a, In FIG. 14, pellets 302a are shown only in a part of material receiving part 303a, but actually the entire region of material receiving part 303a is filled with pellets 302a.

On the other hand, chute 255 is composed as shown in FIG. 15A, B. That is, chute 255 is formed of thin plate materials or the like, and composed of bottom part 255c as a sliding surface of pellets 302a as film forming material 302 in a direction of arrow A, and side parts 255d provide at both sides of bottom part 255c for playing the role as guide plates for sliding of pellets 302a. Side parts 255d have side part 256a and side part 256b, and the passage area formed by right and, left side parts 256b reduced toward lower end part 255b, so that pellets 302a may slide onto a prescribed position of material receiving part 303a.

On at least one of right and left side parts 256b of lower end part 255b, notch part 257 is provided by notching side part 256b. As shown in FIG. 15B, when chute 255 is seen from the side, it is preferred to form notch part 257 so that bottom part 255c may be exposed.

The height of side part 255d from bottom part 255c is preferred to be more than the maximum length of pellets 302a so that pellets 302a may not ride over side part 255dd to drop out of chute 255. Width W of notch part 257 is preferred to be at least more than the maximum length of pellets 302a.

As shown in FIG. 16, lower end part 255b of chute 255 is disposed so that pellets 302a may slide on material receiving part 303a provided in hearth 303, and notch 257 is also provided to be opened into the region of material receiving part 303a.

Thus, chute 255 of film forming material feeding apparatus 200 of preferred embodiment 5 is composed to form notch part 257 at least in one of side parts 256b at lower end part 255b of chute 255. Accordingly, at lower end 255b, pellets 302a are not confined by both side parts 256b. That is, pellets 302a can be discharged to the outer side of chute 255 from notch part 257. Hence, bridge phenomenon is not caused on bottom part 255c of chute 255. As a result, pellets 302a stably slide on chute 255, and are stably supplied into hearth 303, and protective film 109 can be formed stably.

Further, as shown in FIG. 16, in preferred embodiment 5, notch part 257 is opened toward material receiving part 303a provided in hearth 303. That is, outermost end part 258 of notch part 257 is positioned at an inner side of end part 303b of material receiving part 303a. Accordingly, pellets 302a discharged from chute 255 are securely dropped into material receiving part 303a, so that the efficiency of use of pellets 302a is not lowered.

In order that pellets 302a falling from lower end part 255b and notch part 257 of chute 255 may securely fall into material receiving part 303a, in FIG. 14, the center of chute 255 in the longitudinal direction may not be orthogonal to material receiving part 303a, but may be preferred to be disposed so as to incline against material receiving part 303a.

As shown in FIG. 14, meanwhile, in chute 255 of film forming to material feeding apparatus 200 in preferred embodiment 5, notch part 257 of chute 255 is disposed only at the downstream side of the rotating direction of material receiving part 303a out of both side parts 256b. In this configuration, to avoid bridge phenomenon pellets 302a overflowing from notch part 257 are allowed to slide into material receiving part 303a at the downstream side of chute 255. Accordingly, by the pellets 302a overflowing from notch part 257, the gap between chute 255 and material receiving part 303a is not clocked, and phenomenon of blocking of rotation of hearth 303 is not caused.

FIG. 17 is a front view of chute 255 as seen from the front side of hearth 303. As shown in FIG. 17, in chute 255 of film forming material feeding apparatus 200 in preferred embodiment 5, its bottom part 255c, especially bottom part 255c at lower end part 255b is inclined to the surface of hearth 303. In FIG. 17, lower end part 255b is inclined so that distance H1 between hearth 303 and chute 255 at side part 256b having notch part 257 may be greater than distance H2 at the opposite side. In such configuration, usually, pellets 302a may slide securely into a prescribed position of material receiving part 303a of hearth 303. On the other hand, when pellets 302a are supplied massively from feeder 203, a bridge phenomenon may likely to occur, but in such a case, pellets 302a are securely removed from notch part 257 by overflowing, so that occurrence of bridge phenomenon may be suppressed.

In FIG. 17, side part 256b having notch part 257 is inclined to be higher in height, but to the contrary, side part 256b having notch part 257 may be lowered, and usually pellets 302a may be discharged from notch part 257 to slide onto material receiving part 303a.

In the foregoing description, notch part 257 is provided only at one side of side parts 256b, but may be also provided at both sides.

In the foregoing description, individual preferred embodiments are described, but these preferred embodiments may be combined as desired.

In the foregoing description, the film forming material is made of magnesium oxide (MgO), but the material is not limited to magnesium oxide (MgO) alone. The present invention is not limited to supply of film forming material for the PDP alone.

### INDUSTRIAL APPLICABILITY

According to the film forming material feeding apparatus of the present invention, a film forming material can be stably supplied into a film forming apparatus, and the film forming apparatus can be operated stably and continuously, so that the present invention may be applied in a wide range of thin film forming apparatuses.

### DESCRIPTION OF REFERENCE MARKS

### 100 PDP

102 Front panel
103 Front glass substrate
104 Scan electrode
105 Sustain electrode
106 Display electrode
107 Black stripe (light shielding layer)
108 Dielectric layer
109 Protective film
110 Rear panel
111 Rear glass substrate
112 Address electrode
113 Base dielectric layer

### 114 Barrier rib

115 Phosphor layer
116 Discharge space
200 Film forming material feeding apparatus
201 Material hopper
202 Discharge port

### 203 Feeder

203a Drive motor
203b Drive shaft

### 203c Container

204 Feeder discharge port

### 205, 215, 225, 235, 245, 255, 500 Chute

205a, 215a, 235a, 245a, 255a, 500a Upper end part
205b, 215b, 235b, 245b, 255b, 500b Lower end part
215c, 225c, 235c, 245c, 255c, 501 Bottom part
215d, 215d, 235d, 236a, 236b, 245d, 246a, 246b, 255d, 256a, 256b, 502 Side part
215e Arc-shaped part
235e Flat part

### 237 Protrusion

237a R-shaped part
237b Convex part

### 238 Area

247 Wave-shaped protrusion
257 Notch part
258 Outermost end part
300 Film forming apparatus
301 Vacuum chamber
302 Film forming material

### 302a Pellet

### 303 Hearth

303a Material receiving part
303b End part
304 Electron beam source
305 Electron beam
306 Exhaust pump
307 Vacuum gauge

### 308 Heater

309 Shutter plate
310 Deposition particle
311 Film thickness monitor
312 Rotation shaft

1. A film forming material feeding apparatus comprising:
a feeder; and
a chute for sliding a film forming material supplied from the feeder into a material receiving part of a hearth,
wherein the chute has a bottom part for allowing the film forming material to slide, and side parts provided at both sides of the bottom part, and the bottom part and the side parts are connected by way of an arc-shape part.

2. The film forming material feeding apparatus of claim 1, wherein the side parts are raised so as to be at an obtuse angle to the bottom part.

3. The film forming material feeding apparatus of claim 1, wherein the bottom part and the side parts are formed of a continuous arc-shaped part.

4. The film forming material feeding apparatus of claim 1, wherein at least one protrusion is provided in a direction orthogonal to a sliding direction of the film forming material at the bottom part, and within a maximum length of the film forming material.

5. The film forming material feeding apparatus of claim 4, wherein the protrusion is a wave-shaped protrusion provided in the direction orthogonal to the sliding direction of the film forming material.

6. The film forming material feeding apparatus of claim 1, further comprising:
a notch part provided at least at one of the side parts at a downstream side of the sliding direction of the film forming material.

7. The film forming material feeding apparatus of claim 6, wherein the material receiving part is formed of a concentric rotating element, and the notch part is provided at the side part positioned at the downstream side of a rotating direction of the material receiving part.

8. The film forming material feeding apparatus of claim 1, wherein the film forming material is a plate material mainly made of magnesium oxide and having a prescribed thickness.

9. The film forming material feeding apparatus of claim 2, wherein at least one protrusion is provided in a direction orthogonal to a sliding direction of the film forming material at the bottom part, and within a maximum length of the film forming material.
